(19) United States
(12) Patent Application Publication
(10) Pub. No.: US 2019/0353393 A1
(43) Pub. Date: Nov. 21, 2019

(54) INTAKE DUCT FOR INTERNAL COMBUSTION ENGINE

(71) Applicant: TOYOTA BOSHOKU KABUSHIKI KAISHA, Aichi-ken (JP)

(72) Inventors: Ryusuke KIMURA, Ichinomiya-shi (JP); Tomoyo OHNO, Nagoya-shi (JP)

(73) Assignee: TOYOTA BOSHOKU KABUSHIKI KAISHA, Aichi-ken (JP)

(21) Appl. No.: 16/410,218

(22) Filed: May 13, 2019

(30) Foreign Application Priority Data
May 16, 2018 (JP) 2018-094683

(51) Int. Cl. F24F 13/15; G01F 1/684; F02M 35/10

(52) U.S. Cl. CPC F24F 13/15; F24F 2110/40; F02M 35/10032; G01F 1/6842

(57) ABSTRACT

An intake duct for an internal combustion engine includes a tubular side wall made of a fibrous molded body. The side wall includes split bodies that are separate from one another in a circumferential direction of the side wall. Flanges respectively protrude outward from opposite ends in the circumferential direction of each of the split bodies. Each of the flanges includes a low-compression portion and a high-compression portion that is located inward from the low-compression portion. Each of the flanges of each of the split bodies is paired with and in contact with one of the flanges of a corresponding one of the split bodies. A joining portion made of a plastic material is arranged on parts of each pair of the flanges in contact with each other, the parts being located outward from the high-compression portions, the joining portion surrounding and joining the parts to each other.

### BACKGROUND

### 1. Field

The following description relates to an intake duct for an internal combustion engine including a tubular side wall configured by a fibrous molded body that has undergone compression molding.

### 2. Description of Related Art

A typical intake duct for an internal combustion engine is configured by a fibrous molded body that has undergone compression molding (refer to, for example, Japanese Patent No. 5350982). The intake duct described in this document includes a tubular side wall configured by two halved bodies made of nonwoven fabric molded bodies. Each halved body includes edges protruding outward from the opposite ends in the circumferential direction. The edges of the halved bodies are in contact with each other. Covers made of plastic materials are formed through injection-molding to surround the edges, which are in contact with each other. Each cover integrates the halved bodies with each other.

In the intake duct of the above-described document, when the covers are formed, the injected molten plastic may leak out toward the inner side of the side wall through the gaps of the fibers configuring the two halved bodies. In this case, the leaked molten plastic protrudes from the inner circumferential surface of the side wall to become hard, thereby producing burrs. Thus, such burrs increase the airflow resistance of intake air passing through the duct.

### SUMMARY

Accordingly, it is an objective of the present invention to provide an intake duct for an internal combustion engine that limits an increase in airflow resistance.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

An intake duct for an internal combustion engine that solves the above-described objective is provided. The intake duct includes a tubular side wall made of a fibrous molded body that has undergone compression molding. The side wall includes a plurality of split bodies that are separate from one another in a circumferential direction of the side wall. Flanges respectively protrude outward from opposite ends in the circumferential direction of each of the split bodies. Each of the flanges includes a low-compression portion and a high-compression portion. The high-compression portion being located inward from the low-compression portion and formed at a higher compressibility than the low-compression portion. Each of the flanges of each of the split bodies is paired with and in contact with one of the flanges of a corresponding one of the split bodies. A joining portion made of a plastic material is arranged on parts of each pair of the flanges in contact with each other, the parts being located outward from the high-compression portions, the joining portion surrounding and joining the parts to each other.

Other features and aspects will be apparent from the following detailed description, the drawings, and the claims.

### BRIEF DESCRIPTION OF THE DRAWINGS

FIG. 1 is a perspective view showing an intake duct for an internal combustion engine according to the present embodiment.

FIG. 2 is a cross-sectional view taken along line 2-2 in FIG. 1.

FIG. 3 is a cross-sectional view taken along line 3-3 in FIG. 2.

FIG. 4 is a cross-sectional view taken along line 4-4 in FIG. 2.

FIGS. 5A and 5B are schematic diagrams sequentially illustrating the steps of manufacturing a body in the present embodiment, in which FIG. 5A is a schematic diagram illustrating a molding step and FIG. 5B is a schematic diagram illustrating a sliding step.

FIGS. 6A to 6C are cross-sectional views sequentially illustrating the steps of manufacturing a joining portion in the present embodiment, in which FIG. 6A is a cross-sectional view illustrating halved bodies prior to an injection process, FIG. 6B is a cross-sectional view showing the halved bodies and dies in the injection process, and FIG. 6C is a cross-sectional view showing the halved bodies where the joining portion is formed.

FIG. 7 is a cross-sectional view showing an intake duct according to a modification.

FIG. 8 is a cross-sectional view taken along line 8-8 in FIG. 7.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

### First Embodiment

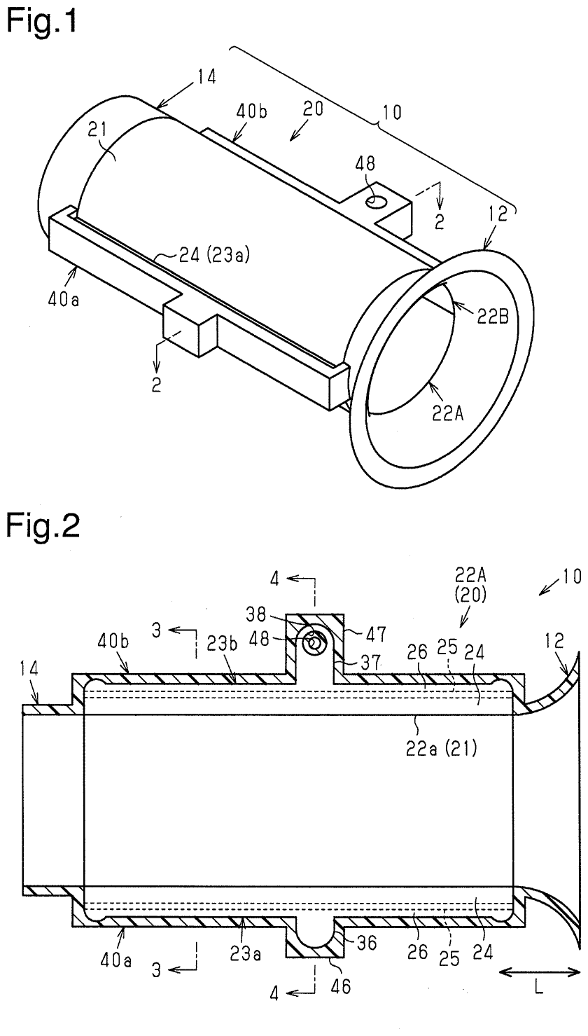

An intake duct for an internal combustion engine (hereinafter referred to as intake duct 10) according to an embodiment will now be described with reference to FIGS. 1 to 6C. In the following description, the upstream side and the downstream side in the flow direction of intake air in the intake duct 10 are simply referred to as an upstream side and a downstream side, respectively.

As shown in FIG. 1, the intake duct 10 includes a tubular fibrous portion 20, a tubular inlet 12, and a tubular connection portion 14. The inlet 12 is located upstream of the fibrous portion 20. The connection portion 14 is located downstream of the fibrous portion 20.

The inlet 12 configures the upstream end of the intake duct 10 and is made of a hard plastic material. The inlet 12 is funnel-shaped such that the inner diameter and the outer diameter increase toward the upstream side. The inner diameter of the downstream end of the inlet 12 is substantially the same as the inner diameter of the upstream end of the fibrous portion 20. Thus, almost no step is formed over the entire circumference between the inner circumferential surface of the downstream end of the inlet 12 and the inner circumferential surface of the upstream end of the fibrous portion 20.

The connection portion 14 configures the downstream end of the intake duct 10 and is made of a hard plastic material. The inner diameter of the upstream end of the connection portion 14 is substantially the same as the inner diameter of the downstream end of the fibrous portion 20. Thus, almost no step is formed over the entire circumference between the inner circumferential surface of the upstream end of the connection portion 14 and the inner circumferential surface of the downstream end of the fibrous portion 20. The downstream end of the connection portion 14 is connected to the inlet (not shown) of an air cleaner.

As shown in FIGS. 1, 3, and 4, the fibrous portion 20 includes a tubular side wall 21. The side wall 21 is made of a fibrous molded body that has undergone compression molding. The side wall 21 includes two tubular halved bodies 22A and 22B that are separate from each other in the circumferential direction. That is, the side wall 21 includes split bodies that are separate from one another in the circumferential direction.

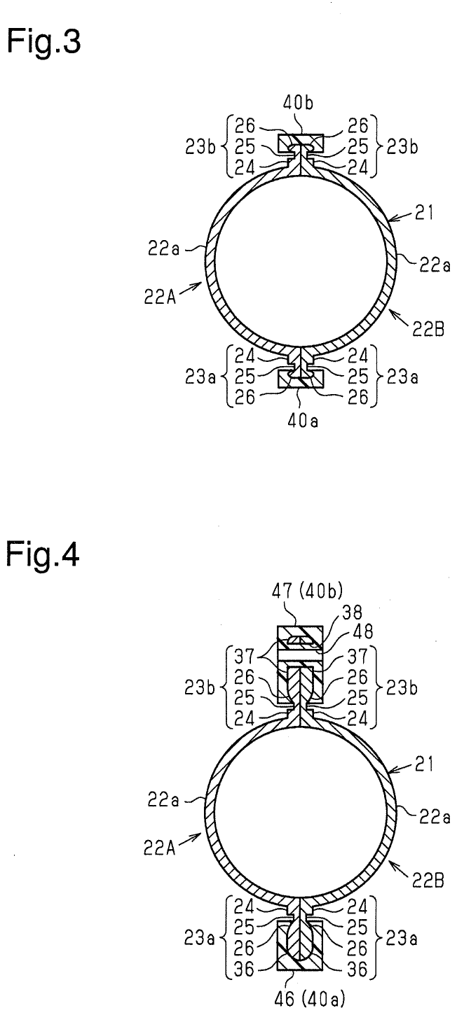

As shown in FIGS. 3 and 4, the halved bodies 22A and 22B are symmetrical with respect to the split surface of the side wall 21. Thus, in the following description, like or same reference numerals are given to the corresponding components of each of the halved bodies 22A and 22B. Such components will not be described.

The halved body 22A (22B) includes a body 22a and two flanges 23a and 23b. The body 22a has the shape of a halved tube. The flanges 23a and 23b protrude outward from the opposite ends in the circumferential direction of the body 22a. The flanges 23a and 23b are arranged over the entire body 22a in the axial direction (hereinafter referred to as axial direction L).

As shown in FIGS. 2 to 4, each of the flanges 23a and 23b of the halved body 22A (22B) includes a first low-compression portion 24, a high-compression portion 25, and a second low-compression portion 26 sequentially from the inner side. The first low-compression portion 24 is formed at the same compressibility as the body 22a. The high-compression portion 25 is formed at a higher compressibility than the first low-compression portion 24. The second low-compression portion 26 is formed at the same compressibility as the first low-compression portion 24.

The first low-compression portions 24, the high-compression portions 25, and the second low-compression portions 26 are arranged entirely in the axial direction L.

As shown in FIGS. 2 and 4, the middle part of the flange 23a of the halved body 22A (22B) in the axial direction L includes a first protrusion 36. The first protrusion 36 protrudes further outward than other parts of the flange 23a.

The middle part of the flange 23b of the halved body 22A (22B) in the axial direction L includes a second protrusion 37. The second protrusion 37 protrudes further outward than other parts of the flange 23b. The protruding length of the second protrusion 37 is greater than the protruding length of the first protrusion 36.

Each of the protrusions 36 and 37 is formed at a lower compressibility than the high-compression portion 25. In the present embodiment, the compressibility of each of the protrusions 36 and 37 is the same as that of the low-compression portions 24 and 26.

The second protrusion 37 includes a through-hole 38 extending through the second protrusion 37 in the thickness direction. The cross-sectional shape of the through-hole 38 is circular.

The fibrous molded body configuring the fibrous portion 20 will now be described.

The fibrous molded body is made of nonwoven fabric configured by a polyethylene terephthalate (PET) fiber and nonwoven fabric of typical core-sheath composite fibers each including, for example, a core (not shown) made of PET and a sheath (not shown) made of denatured PET having a lower melting point than the PET fiber. The denatured PET, which serves as the sheath of the composite fibers, functions as a binder that binds the fibers to each other.

It is preferable that the mixture percentage of denatured PET be 30 to 70%. In the present embodiment, the mixture percentage of denatured PET is 50%.

Such a composite fiber may also include polypropylene (PP) having a lower melting point than PET.

It is preferable that the mass per unit area of the fibrous molded body be 500 to 1500 g/m². In the present embodiment, the mass per unit area of the fibrous molded body is 800 g/m².

The halved bodies 22A and 22B are each formed by thermally compressing (thermally pressing) the above-described nonwoven sheet having a predetermined thickness of, for example, 30 to 100 mm.

The high-compression portion 25 has a breathability (JIS L 1096 A-Method (Frazier Method)) of approximately 0 cm³/cm²·s. Further, it is preferable that the high-compression portion 25 have a thickness of 0.3 to 1.5 mm. In the present embodiment, the high-compression portion 25 has a thickness of 0.7 mm.

The body 22a and the low-compression portions 24 and 26 have a breathability of 3 cm³/cm²·s. Further, it is preferable that the body 22a and the low-compression portions 24 and 26 have a thickness of 1.0 to 3.0 mm. In the present embodiment, the body 22a and the low-compression portions 24 and 26 have a thickness of 1.0 mm.

As shown in FIGS. 2 to 4, the second low-compression portions 26 and the protrusions 36 of the two flanges 23a are surrounded and joined to each other by a joining portion 40a. Likewise, the second low-compression portions 26 and the protrusions 37 of the two flanges 23b are surrounded and joined to each other by a joining portion 40b. The joining portions 40a and 40b are made of hard plastic materials.

As shown in FIGS. 2 and 4, the joining portion 40a includes a first cover 46 that covers the entire first protrusions 36.

The joining portion 40b includes a second cover 47 that covers the entire second protrusions 37.

As shown in FIG. 2, the second cover 47 includes a coupling hole 48 located concentric to the through-hole 38. The coupling hole 48 extends through the second cover 47 in the thickness direction and has a circular cross-sectional shape. That is, the inner circumferential surface of the through-hole 38 is covered by the second cover 47.

The intake duct 10 is coupled to a designated portion of the vehicle by a bolt inserted through the coupling hole 48.

The method for manufacturing the intake duct 10 will now be described.

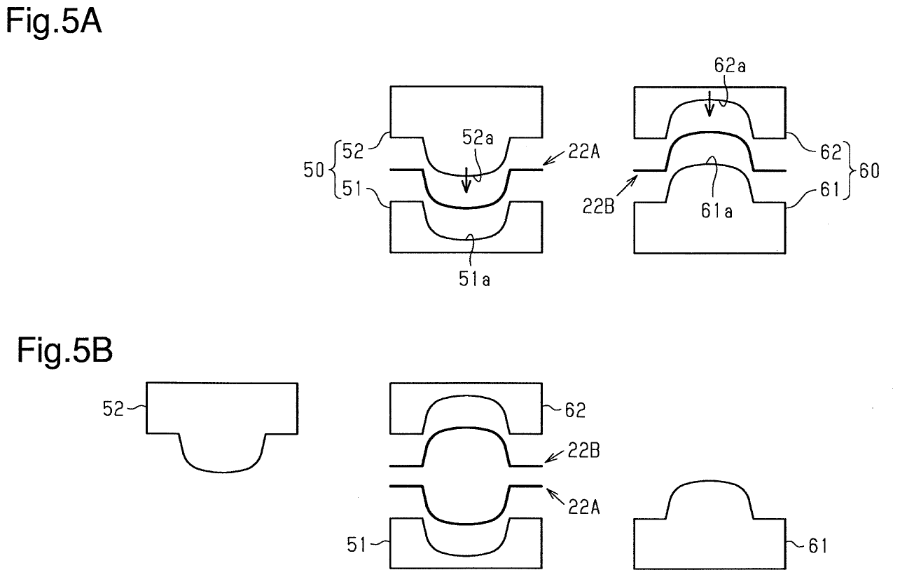

As shown in FIGS. 5A and 5B, the intake duct 10 is manufactured through die slide injection (DSI) molding using two cooling pressing dies (first die 50 and second die 60).

First, two non-woven fabric sheets cut to a predetermined dimension are preliminarily molded through heating and compression using a heat-plate press apparatus (not shown).

Subsequently, the two preliminarily-molded nonwoven fabric sheets are respectively placed between a fixed die portion 51 and a movable die portion 52 of the first die 50 and between a fixed die portion 61 and a movable die portion 62 of the second die 60. The fixed die portion 51 of the first die 50 includes a shaping surface 51a recessed along the outer circumferential surface of the halved body 22A. The movable die portion 52 of the first die 50 includes a shaping surface 52a projected along the inner circumferential surface of the halved body 22A. The fixed die portion 61 of the second die 60 includes a shaping surface 61a projected along the inner circumferential surface of the halved body 22B. The movable die portion 62 of the second die 60 includes a shaping surface 62a recessed along the outer circumferential surface of the halved body 22B.

Then, as shown in FIG. 5A, the movable die portion 52 is moved toward the fixed die portion 51. This forms the non-woven fabric sheet between the fixed die portion 51 and the movable die portion 52 into the shape of a halved tube along the shaping surface 51a of the fixed die portion 51 and the shaping surface 52a of the movable die portion 52. Similarly, the movable die portion 62 is moved toward the fixed die portion 61. This forms the non-woven fabric sheet between the fixed die portion 61 and the movable die portion 62 into the shape of a halved tube along the shaping surface 61a of the fixed die portion 61 and the shaping surface 62a of the movable die portion 62.

The redundant parts of the outer portions of the non-woven fabric sheets are trimmed using trimming blades (not shown) arranged on the fixed die portions 51 and 61 or the movable die portions 52 and 62. This forms the halved bodies 22A and 22B, each of which includes the body 22a and the flanges 23a and 23b.

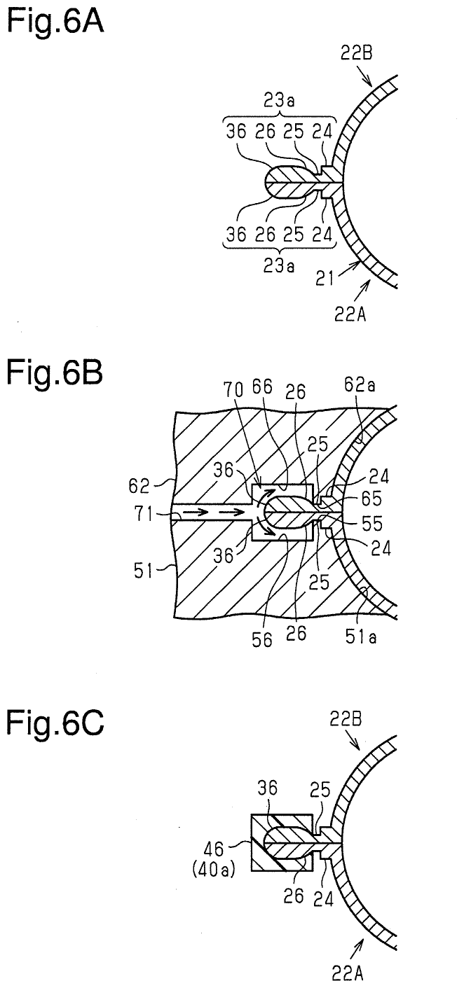

Further, the shaping surface 51a of the fixed die portion 51 of the first die 50 includes a projection 55 (refer to FIG. 6B). The projection 55 and the movable die portion 52 press the non-woven fabric sheet to form the high-compression portions 25 in the flanges 23a and 23b.

In addition, the shaping surface 62a of the movable die portion 62 of the second die 60 includes a projection 65 (refer to FIG. 6B). The projection 65 and the fixed die portion 61 press the non-woven fabric sheet to form the high-compression portions 25 in the flanges 23a and 23b. The parts of the flanges 23a and 23b that are not pressed by the projections 55 and 65 are the low-compression portions 24 and 26.

After the halved bodies 22A and 22B are formed in this manner, the movable die portions 52 and 62 are moved in the direction in which the fixed die portions 51 and 61 are arranged. This moves the halved body 22B together with the movable die portion 62 of the second die 60. As a result, as shown in FIG. 5B, the movable die portion 62 of the second die 60 faces the fixed die portion 51 of the first die 50, and the halved bodies 22A and 22B face each other. This causes the two flanges 23a and 23b of the halved bodies 22A and 22B to come into contact with each other as shown in FIG. 6A.

Afterwards, as shown in FIG. 6B, the fixed die portion 51 of the first die 50 and the movable die portion 62 of the second die 60 are closed. This causes recessed grooves 56 and 66, which are recessed in the shaping surfaces 51a and 62a, to form a cavity 70 that surrounds the second low-compression portions 26 and the first protrusions 36 of the flanges 23a. Although not illustrated in FIG. 6B, the recessed grooves 56 and 66, which form the cavity 70, extend entirely in the axial direction L of the flange 23a to surround the second low-compression portions 26.

Then, molten plastic is injected into the cavity 70 through a gate 71 on the outer side (left side in FIG. 6B) of the first protrusions 36 and a gate (not shown) on the outer side of the second protrusions 37.

As shown in FIG. 6B, the injected molten plastic entirely surrounds the first protrusions 36 and the second low-compression portions 26. Further, the fibers configuring the second low-compression portions 26 are impregnated with the injected molten plastic.

In addition, the high-compression portions 25 have smaller gaps between the fibers than the second low-compression portions 26 and are pressed by the projections 55 and 65 of the dies 50 and 60. This limits inward movement of the molten plastic through the gaps between the fibers.

The shaping surface 51a of the fixed die portion 51 of the first die 50 and the shaping surface 62a of the movable die portion 62 of the second die 60 respectively include recessed grooves (not shown) configuring cavities for molding the inlet 12 and the connection portion 14. When molten plastic is injected into the cavities, the inlet 12 and the connection portion 14 are formed integrally with the flanges 23a and 23b.

After the injected plastic is cooled and hardened, the dies open. This forms the joining portion 40a, which includes the first cover 46, as shown in FIG. 6C. In the same manner, the joining portion 40b, which includes the second cover 47, is formed.

The advantages of the present embodiment will now be described.

(1) The intake duct 10 includes the tubular side wall 21, which is made of a fibrous molded body that has undergone compression molding. The side wall 21 includes the halved bodies 22A and 22B, which are separate from each other in the circumferential direction of the side wall 21. The opposite ends of each of the halved bodies 22A and 22B respectively include the flanges 23a and 23b, which protrude outward. Each of the flanges 23a and 23b includes the first low-compression portion 24, the second low-compression portion 26, and the high-compression portion 25, which is located inward from the second low-compression portion 26 and formed at a higher compressibility than the low-compression portions 24 and 26. The two flanges 23a of the halved bodies 22A and 22B are in contact with each other. That is, the flange 23a of the halved body 22A is paired with and in contact with the flange 23a of the halved body 22B. The joining portion 40a made of a plastic material is arranged on the second low-compression portions 26 of the two flanges 23a located outward from the high-compression portions 25. The joining portion 40a surrounds and joins the second low-compression portions 26 to each other. The two flanges 23b of the halved bodies 22A and 22B are in contact with each other. That is, the flange 23b of the halved body 22A is paired with and in contact with the flange 23b of the halved body 22B. The joining portion 40b made of a plastic material is arranged on the second low-compression portions 26 of the two flanges 23b located outward from the high-compression portions 25. The joining portion 40b surrounds and joins the second low-compression portions 26 to each other.

In such a structure, each of the flanges 23a and 23b of each of the halved bodies 22A and 22B, which configure the side wall 21, includes the second low-compression portion 26 and the high-compression portion 25 sequentially from the outer side. Further, the second low-compression portions 26 of the two flanges 23a, which are in contact with each other, located outward from the high-compression portions 25 are surrounded and joined to each other by the joining portion 40a, which is made of a plastic material. The second low-compression portions 26 of the two flanges 23b, which are in contact with each other, located outward from the high-compression portions 25 are surrounded and joined to each other by the joining portion 40b, which is made of a plastic material. Thus, when the joining portions 40a and 40b are formed through injection-molding, molten plastic is injected from the outer sides of the flanges 23a and 23b so that the fibers configuring the second low-compression portion 26 are impregnated with the molten plastic. Thus, the anchoring effect increases the joining strength of the two flanges 23a, and the joining strength of the two flanges 23b. Further, the high-compression portion 25 has smaller gaps between the fibers than the low-compression portions 24 and 26. Thus, the high-compression portions 25 limit inward movement of the molten plastic through the gaps between the fibers configuring the flanges 23a and 23b. This restricts the molten plastic from leaking out of the inner circumferential surface of the side wall 21. This limits an increase in the airflow resistance.

(2) Parts of the two flanges 23a, which are in contact with each other, include the protrusions 36, which protrude further outward than other parts of the flanges 23a. The joining portion 40a includes the first cover 46, which covers the protrusions 36. Parts of the two flanges 23b, which are in contact with each other, include the protrusions 37, which protrude further outward than other parts of the flanges 23b. The joining portion 40b includes the second cover 47, which covers the protrusions 37.

Each of the protrusions 36 and 37 is formed at a lower compressibility than the high-compression portion 25.

In such a structure, when the joining portions 40a and 40b are formed through injection-molding, molten plastic can be injected from the outer sides of the protrusions 36 and 37 of the flanges 23a and 23b. This lengthens the distance between the gates for injection-molding and the inner circumferential surface of the side wall 21. This further limits inward movement of the molten plastic through the gaps between the fibers configuring the flanges 23a and 23b. Thus, the leakage of the molten plastic out of the inner circumferential surface of the side wall 21 is further restricted.

Since the protrusions 36 and 37 are formed at a lower compressibility than the high-compression portion 25, the gaps between the fibers configuring the protrusions 36 and 37 are impregnated with the molten plastic. Thus, the anchoring effect increases the joining strength of the two protrusions 36, and the joining strength of the two protrusions 37.

(3) The coupling hole 48 extends through the second cover 47.

In such a structure, the coupling hole 48 of the second cover 47 is used to easily couple the intake duct 10 to a subject to be coupled.

In injection-molding, when the fluidity of molten plastic is low at a position where the flows of the molten plastic merge together, the plastics are not mixed together. This may produce welds (weak portions) where the strength is relatively low.

In the above-described structure, when plastic materials are injected from the outer side of the second cover 47, the temperature and the injection pressure of the molten plastic flowing around the coupling hole 48 are kept high. This consequently keeps the fluidity of the molten plastic high. Thus, the production of welds in the second cover 47 is restricted. This limits a decrease in the rigidity around the coupling hole 48.

(4) The coupling hole 48 extends through both the second protrusion 37 and the second cover 47.

In such a structure, the coupling hole 48 extends through both the second protrusion 37, which is made of a fibrous molded body, and the second cover 47, which is made of a plastic material. Thus, the thickness of the entire portion having the coupling hole 48 can be easily adjusted by changing the compressibility of the fibrous molded body configuring the second protrusion 37.

Further, in the above-described structure, the fibers configuring the second protrusion 37 are impregnated with plastic materials. This increases the rigidity around the coupling hole 48.

The above-described embodiment may be modified as described below. The above-described embodiment and the following modifications may be implemented in combination with each other as long as technical contradiction does not occur.

The through-hole 38 of the second protrusion 37 may be omitted, and the coupling hole 48 may extend only through the second cover 47. Such a coupling hole may be arranged in the first cover 46.

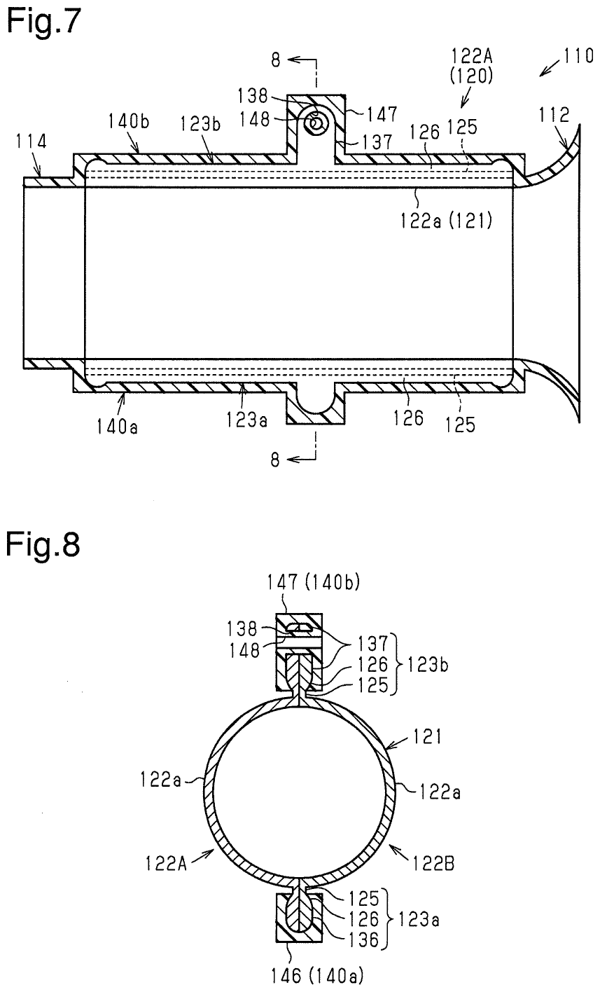

The first low-compression portion 24 may be omitted. As shown in FIGS. 7 and 8, flanges 123a and 123b are arranged on the opposite sides of halved bodies 122A and 122B. The flanges 123a and 123b may respectively include high-compression portions 125 such that the outer circumferential surface of the side wall 121 serves as basal ends. Reference numbers in which number 100 is added to the reference numbers of the components of the above-described structure are given to the components shown in FIGS. 7 and 8. Such components will not be described.

The protrusions 36 and 37 may be omitted. In this case, gates simply need to be arranged on the outer sides of the second low-compression portions 26 of the flanges 23a and 23b to inject molten plastic.

Each of the protrusions 36 and 37 simply needs to be formed at a lower compressibility than the high-compression portion 25. The compressibility of each of the protrusions 36 and 37 may differ from that of the low-compression portions 24 and 26.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. An intake duct for an internal combustion engine, the intake duct comprising a tubular side wall made of a fibrous molded body that has undergone compression molding, wherein
the side wall includes a plurality of split bodies that are separate from one another in a circumferential direction of the side wall,
flanges respectively protrude outward from opposite ends in the circumferential direction of each of the split bodies,
each of the flanges includes a low-compression portion and a high-compression portion, the high-compression portion being located inward from the low-compression portion and formed at a higher compressibility than the low-compression portion,
each of the flanges of each of the split bodies is paired with and in contact with one of the flanges of a corresponding one of the split bodies, and
a joining portion made of a plastic material is arranged on parts of each pair of the flanges in contact with each other, the parts being located outward from the high-compression portions, the joining portion surrounding and joining the parts to each other.

2. The intake duct according to claim 1, wherein
a part of each of the two flanges, which are in contact with each other, includes a protrusion, the protrusions of the two flanges protruding further outward than other parts of the two flanges,
each of the joining portions includes a cover that covers the corresponding protrusions, and
each of the protrusions is formed at a lower compressibility than the high-compression portions.

3. The intake duct according to claim 2, wherein at least one of the covers includes a coupling hole that extends through the cover.

4. The intake duct according to claim 3, wherein the coupling hole extends through both the corresponding cover and the protrusions covered by the cover.
